(19) United States
(12) Patent Application Publication
(10) Pub. No.: US 2025/0164747 A1
(43) Pub. Date: May 22, 2025

(54) IMAGE CAPTURING LENS

(71) Applicant: GUANGZHOU LUXVISIONS INNOVATION TECHNOLOGY LIMITED, Guangzhou City (CN)

(72) Inventors: Chuan-Hui Liu, Guangzhou City (CN); Shih-Chieh Yen, Guangzhou City (CN)

(73) Assignee: GUANGZHOU LUXVISIONS INNOVATION TECHNOLOGY LIMITED, Guangzhou City (CN)

(21) Appl. No.: 18/822,431

(22) Filed: Sep. 2, 2024

Related U.S. Application Data
(60) Provisional application No. 63/600,724, filed on Nov. 19, 2023.

(30) Foreign Application Priority Data
Jul. 23, 2024 (CN) 202410990861.2

(51) Int. Cl. G02B 13/00; G02B 9/16

(52) U.S. Cl. CPC G02B 13/0035; G02B 9/16; G02B 13/0065

(57) ABSTRACT

An image capturing lens, sequentially including a first lens element, a second lens element, a third lens element, and a light turning component from an object side to an image side along an optical axis. The first lens element, the second lens element, and the third lens element have refracting power. The light turning component includes a first prism and a second prism along the optical axis. The first prism includes a first light incident surface, a first reflective surface, and a first light exit surface. The second prism includes a second light incident surface, a second reflective surface, and a second light exit surface. The first light exit surface and the second light incident surface are parallel to each other. The optical axis bends at the first reflective surface and the second reflective surface.

### CROSS-REFERENCE TO RELATED APPLICATION

This application claims the priority benefit of U.S. provisional application Ser. No. 63/600,724, filed on Nov. 19, 2023 and China application serial no. 202410990861.2, filed on Jul. 23, 2024. The entirety of each of the above-mentioned patent applications is hereby incorporated by reference herein and made a part of this specification.

### BACKGROUND

### Technical Field

The disclosure relates to an optical element, and in particular to an image capturing lens.

### Description of Related Art

The specifications of portable electronic devices are changing rapidly, and optical image capturing lenses, as a type of key parts and components, are also developing in increasingly diverse ways. However, the specific size of portable electronic devices restricts the total track length (TTL) of the image capturing lenses inside. Moreover, long-focus lenses have a larger total track length, resulting in challenges to dispose long-focus lenses in portable electronic devices.

### SUMMARY

The disclosure provides an image capturing lens that is a long-focus lens and adaptable to be accommodated in a portable electronic device with limited internal space.

According to an embodiment of the disclosure, an image capturing lens is provided. The image capturing lens sequentially includes a first lens element, a second lens element, a third lens element, and a light turning component from an object side to an image side along an optical axis. The first lens element, the second lens element, and the third lens element have refracting power. The light turning component includes a first prism and a second prism along the optical axis. The first prism includes a first light incident surface, a first reflective surface, and a first light exit surface. The second prism includes a second light incident surface, a second reflective surface, and a second light exit surface. The first light exit surface and the second light incident surface are parallel to each other. The optical axis bends at the first reflective surface and the second reflective surface.

Based on the above, the image capturing lens provided in the embodiment of the disclosure includes a light turning component. By folding an optical path through the light turning component, the length of the image capturing lens is reduced, realizing the purpose of accommodating a long-focus lens in a limited space while maintaining good optical performance for the image capturing lens.

To make the features and advantages of the disclosure more comprehensible, several embodiments accompanied with drawings are described in detail as follows.

### BRIEF DESCRIPTION OF THE DRAWINGS

FIGS. 1A and 1B show schematic diagrams of an image capturing lens according to a first embodiment of the disclosure.

FIGS. 1C and 1D are field curvature schematic diagrams of of the image capturing lens in the first embodiment.

FIG. 1E is a distortion schematic diagram of the image capturing lens in the first embodiment.

FIGS. 2A and 2B show schematic diagrams of an image capturing lens according to a second embodiment of the disclosure.

FIGS. 2C and 2D are field curvature schematic diagrams of of the image capturing lens in the second embodiment.

FIG. 2E is a distortion schematic diagram of the image capturing lens in the second embodiment.

FIGS. 3A and 3B show schematic diagrams of an image capturing lens according to a third embodiment of the disclosure.

FIGS. 3C and 3D are field curvature schematic diagrams of the image capturing lens in the third embodiment.

FIG. 3E is a distortion schematic diagram of the image capturing lens in the third embodiment.

### DESCRIPTION OF THE EMBODIMENTS

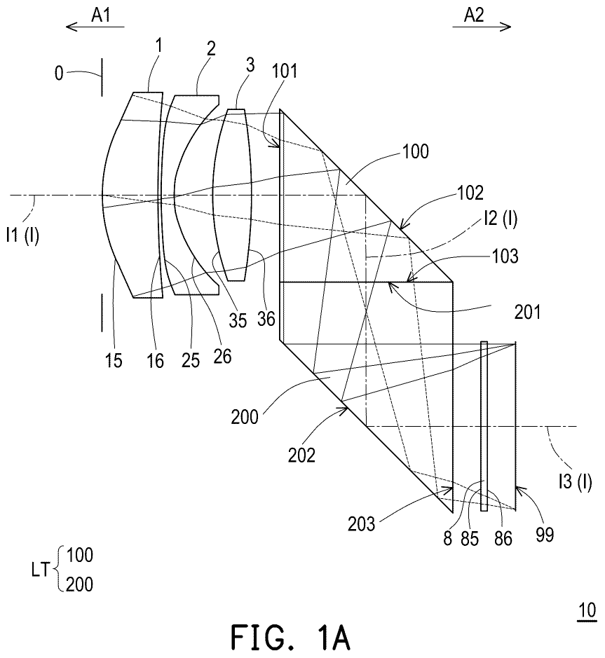

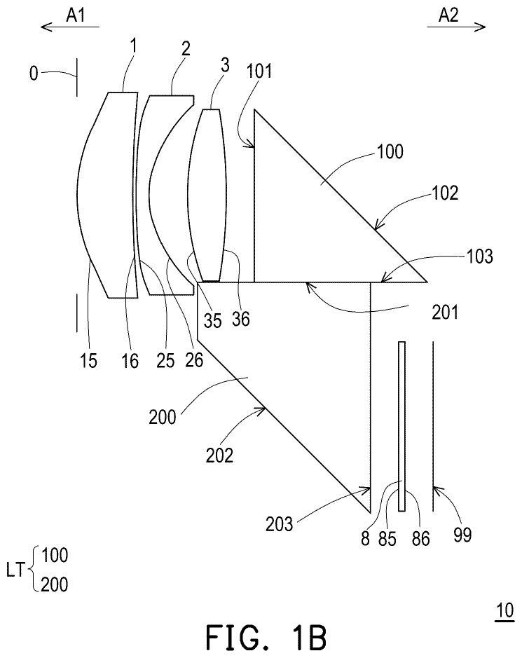

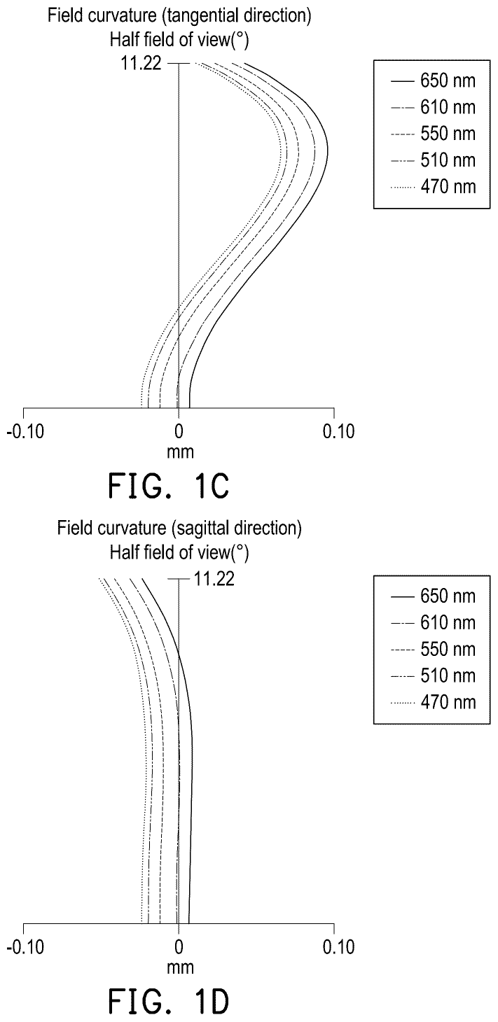

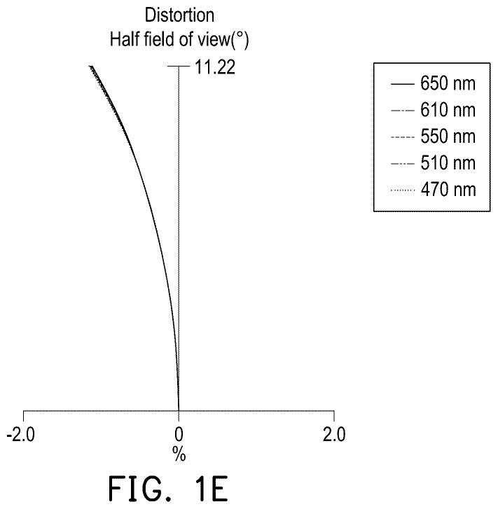

Please refer to FIGS. 1A and 1B, which respectively show a schematic diagram of an image capturing lens in a usage state and a non-usage state according to a first embodiment of the disclosure. An image capturing lens 10 in the first embodiment includes a stop 0, a first lens element 1, a second lens element 2, a third lens element 3, a light turning component LT, and a filter 8 sequentially from an object side A1 to an image side A2 along an optical axis I of the image capturing lens 10. When light emitted from an object to be imaged enters the image capturing lens 10 and sequentially penetrates the stop 0, the first lens element 1, the second lens element 2, the third lens element 3, the light turning component LT, and the filter 8, an image is formed on an image surface 99. The filter 8 is, for example, an infrared cut-off filter, which allows light with appropriate wavelengths (such as infrared or visible light) to pass through while filtering out unwanted infrared wave bands. The filter 8 is disposed between the light turning component LT and the image surface 99. In addition, the object side A1 faces the object to be imaged while the image side A2 faces the image surface 99.

In this embodiment, the first lens element 1, the second lens element 2, the third lens element 3, and the filter 8 of the image capturing lens 10 respectively have object side surfaces 15, 25, 35, and 85 facing the object side A1 and allowing imaging light to pass through. The first lens element 1, the second lens element 2, the third lens element 3, and the filter 8 of the image capturing lens 10 also respectively have image side surfaces 16, 26, 36, and 86 facing the image side A2 and allowing imaging light to pass through.

The first lens element 1 has positive refracting power, with an optical axis area of the object side surface 15 being a convex surface and an optical axis area of the image side surface 16 being a concave surface. Both the object side surface 15 and the image side surface 16 are aspheric surfaces.

The second lens element 2 has negative refracting power, with an optical axis area of the object side surface 25 being a convex surface and an optical axis area of the image side surface 26 being a concave surface. Both the object side surface 25 and the image side surface 26 are aspheric surfaces.

The third lens element 3 has positive refracting power, with an optical axis area of the object side surface 35 being a convex surface and an optical axis area of the image side surface 36 being a convex surface. Both the object side surface 35 and the image side surface 36 are aspheric surfaces.

The optical axis I includes a first optical axis I1, a second optical axis I2, and a third optical axis I3. The light turning component LT includes a first prism 100 and a second prism 200 configured along the second optical axis I2. The first prism 100 includes a first light incident surface 101, a first reflective surface 102, and a first light exit surface 103. The second prism 200 includes a second light incident surface 201, a second reflective surface 202, and a second light exit surface 203. All of the surfaces are planar surfaces, with the first light exit surface 103 and the second light incident surface 201 being parallel to each other, and the first reflective surface 102 and the second reflective surface 202 being parallel to each other. The first optical axis I1 and the second optical axis I2 intersect at the first reflective surface 102. The second optical axis I2 and the third optical axis I3 intersect at the second reflective surface 202. When light enters the image capturing lens 10 along the first optical axis I1, the light travels along the second optical axis I2 after being reflected by the first reflective surface 102, and then travels along the third optical axis I3 after being reflected by the second reflective surface 202. In some embodiments, the first reflective surface 102 and the second reflective surface 202 may be coated with aluminum and/or silver to increase the reflectivity of light.

When light enters the image capturing lens 10, the light sequentially: penetrates the stop 0, the first lens element 1, the second lens element 2, the third lens element 3, and the first light incident surface 101; be reflected by the first reflective surface 102; penetrates the first light exit surface 103 and the second light incident surface 201; be reflected by the second reflective surface 202; and penetrates the second light exit surface 203 and the filter 8. The first reflective surface 102 and the second reflective surface 202 are the inner surfaces of the first prism 100 and the second prism 200 respectively.

It should be noted that by configuring the light turning component LT in the image capturing lens 10 in this embodiment, an optical path is folded and thus reduces the length of the image capturing lens 10. Accordingly, the image capturing lens 10 can be accommodated in a limited space, such as a mobile phone case.

Other detailed optical statistics of the first embodiment are shown in Table 1. An image height (ImgH) is half of a diagonal of the image surface 99. The first light incident surface 101, the first reflective surface 102, the first light exit surface 103, the second light incident surface 201, the second reflective surface 202, and the second light exit surface 203 are respectively abbreviated as incident surface 101, reflective surface 102, exit surface 103, incident surface 201, reflective surface 202, and exit surface 203.

TABLE 1
First Embodiment
Effective focal length = 15 mm; Full field of view = 22.4°;
Stop value = 2.0; ImgH = 2.944 mm.

| | | Radius of | | | |
|---|---|---|---|---|---|
| | | curvature | Distance | Refractive | Abbe |
| Element | Surface | (mm) | (mm) | index | number |
| Object | | Infinite | Infinite | | |
| | Stop 0 | Infinite | 0.00 | | |
| First lens | Object side | 5.15 | 1.95 | 1.55 | 56.10 |
| element 1 | surface 15 | | | | |
| | Image side | 39.56 | 0.10 | | |
| | surface 16 | | | | |
| Second lens | Object side | 18.53 | 0.45 | 1.61 | 25.60 |
| element 2 | surface 25 | | | | |
| | Image side | 3.35 | 1.33 | | |
| | surface 26 | | | | |
| Third lens | Object side | 10.13 | 1.34 | 1.55 | 56.10 |
| element 3 | surface 35 | | | | |
| | Image side | −19.50 | 1.00 | | |
| | surface 36 | | | | |
| First prism 100 | Incident | Infinite | 3.00 | 1.52 | 64.17 |
| | surface 101 | | | | |
| | Reflective | Infinite | 3.00 | | |
| | surface 102 | | | | |
| | Exit surface | Infinite | 0.00 | | |
| | 103 | | | | |
| Second prism | Incident | Infinite | 5.00 | 1.52 | 64.17 |
| 200 | surface 201 | | | | |
| | Reflective | Infinite | 3.00 | | |
| | surface 202 | | | | |
| | Exit surface | Infinite | 1.00 | | |
| | 203 | | | | |
| Filter 8 | Object side | Infinite | 0.21 | 1.52 | 64.17 |
| | surface 85 | | | | |
| | Image side | Infinite | 1.00 | | |
| | surface 86 | | | | |
| | Image | Infinite | | | |
| | surface 99 | | | | |

In Table 1, a spacing of the object side surface 15 is a thickness of the first lens element 1 along the optical axis I (the first optical axis I1). A spacing of the image side surface 16 is a distance between the image side surface 16 of the first lens element 1 and the object side surface 25 of the second lens element 2 along the optical axis I (the first optical axis I1), i.e., a gap between the first lens element 1 and the second lens element 2 along the optical axis I (the first optical axis I1), and so forth.

A spacing of the image side surface 36 is a distance between the image side surface 36 of the third lens element 3 and the first light incident surface 101 of the first prism 100 along the optical axis I (the first optical axis I1), i.e., a gap between the third lens element 3 and the first prism 100 along the optical axis I (the first optical axis I1).

A spacing of the first light incident surface 101 is a distance between the first light incident surface 101 and the first reflective surface 102 along the optical axis I (the first optical axis I1). A spacing of the first reflective surface 102 is a distance between the first reflective surface 102 and the first light exit surface 103 along the optical axis I (the second optical axis I2). A spacing of the first light exit surface 103 is a distance between the first light exit surface 103 and the second light incident surface 201 along the optical axis I (the second optical axis I2). A spacing of the second light incident surface 201 is a distance between the second light incident surface 201 and the second reflective surface 202 along the optical axis I (the second optical axis I2). A spacing of the second reflective surface 202 is a distance between the second reflective surface 202 and the second light exit surface 203 along the optical axis I (the third optical axis I3).

A spacing of the second light exit surface 203 is a gap between the second prism 200 and the filter 8 along the optical axis I (the third optical axis I3). A spacing of the object side surface 85 of the filter 8 is a thickness of the filter 8 along the optical axis I (the third optical axis I3). A spacing of the image side surface 86 of the filter 8 is a gap between the filter 8 and the image surface 99 along the optical axis I (the third optical axis I3).

It should be particularly noted that, according to an embodiment, the image capturing lens 10 may further include a moving mechanism. The moving mechanism is configured to move the first lens element 1, the second lens element 2, the third lens element 3, and the first prism 100 along a stretching direction at the same time, wherein the stretching direction is parallel to the first optical axis I1. During the movement, the gaps between the first lens element 1, the second lens element 2, the third lens element 3, and the first prism 100 remain the same as the statistics shown in Table 1. During the movement, there may be a slight gap between the first light exit surface 103 and the second light incident surface 201. Moreover, the moving mechanism moves the first lens element 1, the second lens element 2, the third lens element 3, and the first prism 100 by a distance of less than 3 mm. By configuring the moving mechanism, the image capturing lens 10 may switch between the usage state shown in FIG. 1A and the non-usage state shown in FIG. 1B, further reducing the lens length in the non-usage state.

In this embodiment, the object side surfaces 15, 25, and 35 of the first lens element 1, the second lens element 2, and the third lens element 3, as well as the image side surfaces 16, 26, and 36 of the first lens element 1, the second lens element 2, and the third lens element 3, are all aspheric surfaces. The aspheric surfaces are defined according to a formula (1) below.

$$Z ( Y ) = \frac{{Y}^{2}}{R} / ( 1 + \sqrt{1 - ( 1 - K ) \frac{{Y}^{2}}{{R}^{2}} )} + {\sum }_{i = 1}^{n} {a}_{2 i} \times {Y}^{2 i} \qquad ( 1 )$$

Y: Distance between a point on the curve of the aspheric surface and the optical axis.
Z: Aspheric depth, i.e., a vertical distance between a point on the aspheric surface at the distance Y from the optical axis and a tangential surface at the vertex of the aspheric surface on the optical axis.
R: Radius of curvature of the lens surface.
K: Conic constant.
a2i: 2i-th order aspheric coefficient.

In this embodiment, the conic constant K and each aspheric coefficients in the aspheric surface formula (1) are shown in Table 2. In Table 2, No. 15 indicates the aspheric coefficients of the object side surface 15 of the first lens element 1, and No. 16 indicates the aspheric coefficients of the image side surface 16 of the first lens element 1. The other numbers follow the same analog.

TABLE 2

| Surface | K | a₄ | a₆ | a₈ |
|---|---|---|---|---|
| 15 | 0.00E+00 | −1.74E−04 | −1.64E−05 | −5.91E−06 |
| 16 | 0.00E+00 | −3.77E−03 | 1.44E−03 | −2.55E−04 |
| 25 | 0.00E+00 | −3.61E−03 | 1.15E−03 | −1.98E−04 |
| 26 | 0.00E+00 | −4.88E−04 | −4.35E−04 | −9.66E−05 |
| 35 | 0.00E+00 | 1.70E−03 | −1.28E−04 | −9.34E−05 |
| 36 | 0.00E+00 | −1.82E−04 | 3.65E−05 | −4.96E−05 |
| Surface | a₁₀ | a₁₂ | a₁₄ | a₁₆ |
| 15 | 4.05E−07 | −3.46E−08 | 1.41E−09 | −2.93E−11 |
| 16 | 2.54E−05 | −1.44E−06 | 4.20E−08 | −5.25E−10 |
| 25 | 2.08E−05 | −1.18E−06 | 3.47E−08 | −5.31E−10 |
| 26 | 3.05E−05 | −3.52E−06 | 2.01E−07 | −5.16E−09 |
| 35 | 2.13E−05 | −2.17E−06 | 1.09E−07 | −2.41E−09 |
| 36 | 1.17E−05 | −1.28E−06 | 6.71E−08 | −1.48E−09 |

Please further refer to FIGS. 1C to 1E. FIG. 1C shows a curve chart of field curvature aberrations in a tangential direction when light with wavelengths of 470 nm, 510 nm, 555 nm, 610 nm, and 650 nm is incident on the image capturing lens 10 in the first embodiment. FIG. 1D shows a curve chart of field curvature aberrations in a sagittal direction when the light with wavelengths of 470 nm, 510 nm, 555 nm, 610 nm, and 650 nm is incident on the image capturing lens 10 in the first embodiment. FIG. 1E shows a distortion curve chart when the light with wavelengths of 470 nm, 510 nm, 555 nm, 610 nm, and 650 nm is incident on the image capturing lens 10 in the first embodiment.

As shown in the field curvature aberration curve charts of FIGS. 1C and 1D, the field curvature aberrations of the five representative wavelengths fall within +0.10 mm across the entire field of view, meaning that the image capturing lens 10 in the first embodiment can effectively eliminate field curvature aberrations. As shown in the distortion curve chart of FIG. 1E, the distortion aberrations of the five representative wavelengths are less than ±1.2% across the entire field of view, meaning that the image capturing lens 10 in the first embodiment has good imaging quality.

To fully illustrate various implementations of the disclosure, other embodiments will be described below. It should be noted that the same reference numerals and a part of the content from the previous embodiment are used in the following embodiments. The same numerals represent the same or similar elements, and descriptions of the same technical content are omitted. References may be made to the previous embodiment for the omitted descriptions, which will not be repeated in the following embodiments.

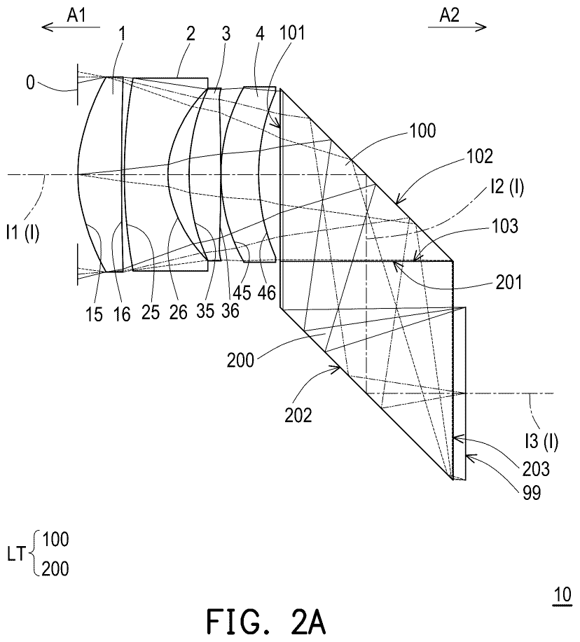

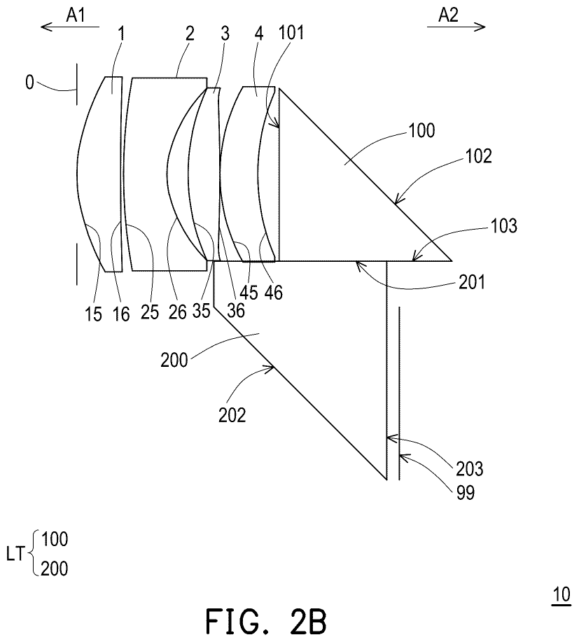

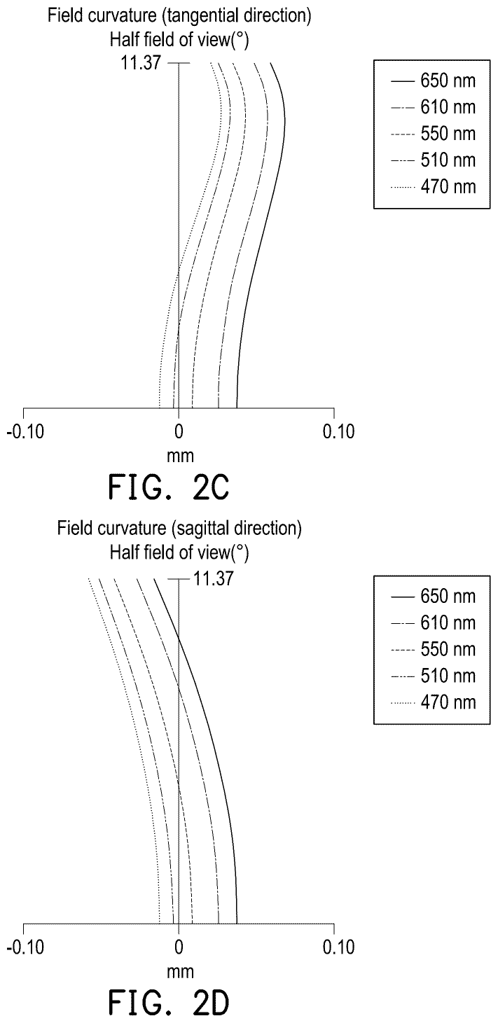

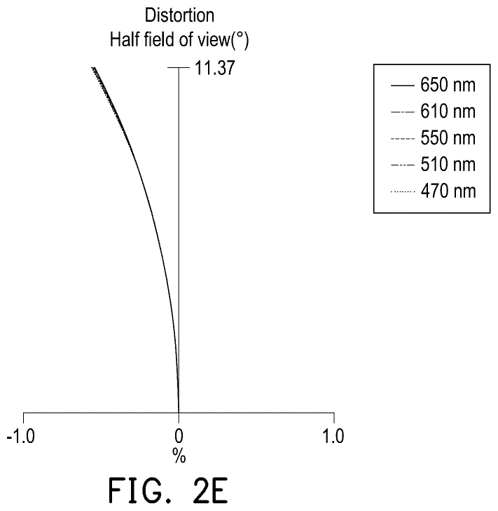

Please refer to FIGS. 2A and 2B, which respectively show a schematic diagram of an image capturing lens in a usage state and a non-usage state according to a second embodiment of the disclosure. The image capturing lens 10 in the second embodiment includes the stop 0, the first lens element 1, the second lens element 2, the third lens element 3, a fourth lens element 4, and the light turning component LT sequentially from the object side A1 to the image side A2 along the optical axis I of the image capturing lens 10. When light emitted from an object to be imaged enters the image capturing lens 10 and sequentially penetrates the stop 0, the first lens element 1, the second lens element 2, the third lens element 3, the fourth lens element 4, and the light turning component LT, an image is formed on the image surface 99.

In this embodiment, the first lens element 1, the second lens element 2, the third lens element 3, and the fourth lens element 4 of the image capturing lens 10 respectively have object side surfaces 15, 25, 35, and 45 facing the object side A1 and allowing imaging light to pass through. The first lens element 1, the second lens element 2, the third lens element 3, and the fourth lens element 4 of the image capturing lens 10 also respectively have image side surfaces 16, 26, 36, and 46 facing the image side A2 and allowing imaging light to pass through.

The first lens element 1 has positive refracting power, with the optical axis area of the object side surface 15 being a convex surface and the optical axis area of the image side surface 16 being a concave surface. Both the object side surface 15 and the image side surface 16 are aspheric surfaces.

The second lens element 2 has negative refracting power, with the optical axis area of the object side surface 25 being a convex surface and the optical axis area of the image side surface 26 being a concave surface. Both the object side surface 25 and the image side surface 26 are aspheric surfaces.

The third lens element 3 has positive refracting power, with the optical axis area of the object side surface 35 being a convex surface and the optical axis area of the image side surface 36 being a convex surface. Both the object side surface 35 and the image side surface 36 are aspheric surfaces.

The fourth lens element 4 has positive refracting power, with an optical axis area of the object side surface 45 being a convex surface and an optical axis area of the image side surface 46 being a concave surface. Both the object side surface 45 and the image side surface 46 are aspheric surfaces.

The optical axis I includes the first optical axis I1, the second optical axis I2, and the third optical axis I3. The light turning component LT includes the first prism 100 and the second prism 200 configured along the second optical axis I2. The first prism 100 includes the first light incident surface 101, the first reflective surface 102, and the first light exit surface 103. The second prism 200 includes the second light incident surface 201, the second reflective surface 202, and the second light exit surface 203. All of the surfaces are planar surfaces, with the first light exit surface 103 and the second light incident surface 201 being parallel to each other, and the first reflective surface 102 and the second reflective surface 202 being parallel to each other. The first optical axis I1 and the second optical axis I2 intersect at the first reflective surface 102. The second optical axis I2 and the third optical axis I3 intersect at the second reflective surface 202. When light enters the image capturing lens 10 along the first optical axis I1, the light travels along the second optical axis I2 after being reflected by the first reflective surface 102, and then travels along the third optical axis I3 after being reflected by the second reflective surface 202. In some embodiments, the first reflective surface 102 and the second reflective surface 202 may be coated with aluminum and/or silver to increase the reflectivity of light.

When light enters the image capturing lens 10, the light sequentially: penetrates the stop 0, the first lens element 1, the second lens element 2, the third lens element 3, the fourth lens element 4, and the first light incident surface 101; be reflected by the first reflective surface 102; penetrates the first light exit surface 103 and the second light incident surface 201; be reflected by the second reflective surface 202; and penetrates the second light exit surface 203. The first reflective surface 102 and the second reflective surface 202 are the inner surfaces of the first prism 100 and the second prism 200 respectively.

It should be noted that by configuring the light turning component LT in the image capturing lens 10 in this embodiment, an optical path is folded and thus reduces the length of the image capturing lens 10. Accordingly, the image capturing lens 10 can be accommodated in a limited space, such as a mobile phone case.

Other detailed optical statistics of the second embodiment are shown in Table 3. The image height (ImgH) is half of the diagonal of the image surface 99. The first light incident surface 101, the first reflective surface 102, the first light exit surface 103, the second light incident surface 201, the second reflective surface 202, and the second light exit surface 203 are respectively abbreviated as incident surface 101, reflective surface 102, exit surface 103, incident surface 201, reflective surface 202, and exit surface 203.

TABLE 3
Second Embodiment
Effective focal length = 20 mm; Full field of view = 22.7°;
Stop value = 2.2; ImgH = 4.0 mm.

| | | Radius of | | | |
|---|---|---|---|---|---|
| | | curvature | Distance | Refractive | Abbe |
| Element | Surface | (mm) | (mm) | index | number |
| Object | | Infinite | Infinite | | |
| | Stop 0 | Infinite | 0.00 | | |
| First lens | Object side | 7.11 | 2.00 | 1.55 | 56.10 |
| element 1 | surface 15 | | | | |
| | Image side | 66.92 | 0.13 | | |
| | surface 16 | | | | |
| Second lens | Object side | 30.30 | 1.97 | 1.61 | 25.60 |
| element 2 | surface 25 | | | | |
| | Image side | 4.44 | 0.97 | | |
| | surface 26 | | | | |
| Third lens | Object side | 12.86 | 1.45 | 1.55 | 56.10 |
| element 3 | surface 35 | | | | |
| | Image side | −36.10 | 0.02 | | |
| | surface 36 | | | | |
| Fourth lens | Object side | 8.49 | 1.70 | 1.61 | 25.60 |
| element 4 | surface 45 | | | | |
| | Image side | 8.61 | 1.00 | | |
| | surface 46 | | | | |
| First prism 100 | Incident | Infinite | 4.00 | 1.52 | 64.17 |
| | surface 101 | | | | |
| | Reflective | Infinite | 4.00 | | |
| | surface 102 | | | | |
| | Exit surface | Infinite | 0.00 | | |
| | 103 | | | | |
| Second prism | Incident | Infinite | 6.00 | 1.52 | 64.17 |
| 200 | surface 201 | | | | |
| | Reflective | Infinite | 4.00 | | |
| | surface 202 | | | | |
| | Exit surface | Infinite | 0.50 | | |
| | 203 | | | | |
| | Image | Infinite | | | |
| | surface 99 | | | | |

In Table 3, the spacing of the object side surface 15 is the thickness of the first lens element 1 along the optical axis I (the first optical axis I1). The spacing of the image side surface 16 is the distance between the image side surface 16 of the first lens element 1 and the object side surface 25 of the second lens element 2 along the optical axis I (the first optical axis I1), i.e., the gap between the first lens element 1 and the second lens element 2 along the optical axis I (the first optical axis I1), and so forth.

A spacing of the image side surface 46 is a distance between the image side surface 46 of the fourth lens element 4 and the first light incident surface 101 of the first prism 100 along the optical axis I (the first optical axis I1), i.e., a gap between the fourth lens element 4 and the first prism 100 along the optical axis I (the first optical axis I1).

The spacing of the first light incident surface 101 is the distance between the first light incident surface 101 and the first reflective surface 102 along the optical axis I (the first optical axis I1). The spacing of the first reflective surface 102 is the distance between the first reflective surface 102 and the first light exit surface 103 along the optical axis I (the second optical axis I2). The spacing of the first light exit surface 103 is the distance between the first light exit surface 103 and the second light incident surface 201 along the optical axis I (the second optical axis I2). The spacing of the second light incident surface 201 is the distance between the second light incident surface 201 and the second reflective surface 202 along the optical axis I (the second optical axis I2). The spacing of the second reflective surface 202 is the distance between the second reflective surface 202 and the second light exit surface 203 along the optical axis I (the third optical axis I3).

The spacing of the second light exit surface 203 is a gap between the second prism 200 and the image surface 99 along the optical axis I (the third optical axis I3).

It should be particularly noted that, according to an embodiment, the image capturing lens 10 may further include a moving mechanism. The moving mechanism is configured to move the first lens element 1, the second lens element 2, the third lens element 3, the fourth lens element 4, and the first prism 100 along a stretching direction at the same time, wherein the stretching direction is parallel to the first optical axis I1. During the movement, the gaps between the first lens element 1, the second lens element 2, the third lens element 3, the fourth lens element 4, and the first prism 100 remain the same as the statistics shown in Table 3. During the movement, there may be a slight gap between the first light exit surface 103 and the second light incident surface 201. Moreover, the moving mechanism moves the first lens element 1, the second lens element 2, the third lens element 3, the fourth lens element 4, and the first prism 100 by a distance of less than 3 mm. By configuring the moving mechanism, the image capturing lens 10 may switch between the usage state shown in FIG. 2A and the non-usage state shown in FIG. 2B, further reducing the lens length in the non-usage state.

In this embodiment, the object side surfaces 15, 25, 35, and 45 of the first lens element 1, the second lens element 2, the third lens element 3, and the fourth lens element 4, as well as the image side surfaces 16, 26, 36, and 46 of the first lens element 1, the second lens element 2, the third lens element 3, and the fourth lens element 4 are all aspheric surfaces. The aspheric surfaces are defined according to the aspheric surface formula (1).

In this embodiment, the conic constant K and each aspheric coefficients in the aspheric surface formula (1) are shown in Table 4. In Table 4, No. 15 indicates the aspheric coefficients of the object side surface 15 of the first lens element 1, and No. 16 indicates the aspheric coefficients of the image side surface 16 of the first lens element 1. The other numbers follow the same analog.

TABLE 4

| Surface | K | a₄ | a₆ | a₈ |
|---|---|---|---|---|
| 15 | 0.00E+00 | −6.22444E−05 | 6.528E−06 | −7.72504E−07 |
| 16 | 0.00E+00 | −0.001457483 | 0.0002691 | −2.41193E−05 |
| 25 | 0.00E+00 | −0.001293099 | 0.0002119 | −1.89548E−05 |
| 26 | 0.00E+00 | −0.000301502 | −9.04E−05 | −9.21358E−06 |
| 35 | 0.00E+00 | 0.000448337 | −2.03E−05 | −8.93932E−06 |
| 36 | 0.00E+00 | 0.000290467 | 1.472E−05 | −3.39705E−06 |
| 45 | 0.00E+00 | 0.000104732 | −9.05E−07 | −1.45724E−07 |
| 46 | 0.00E+00 | −0.000175223 | −2.1E−06 | −2.03827E−06 |

| Surface | a₁₀ | a₁₂ | a₁₄ | a₁₆ |
|---|---|---|---|---|
| 15 | 1.06809E−08 | −1.00339E−09 | 1.36979E−11 | −5.88075E−13 |
| 16 | 1.22567E−06 | −3.60723E−08 | 5.18611E−10 | −3.38678E−12 |
| 25 | 1.00915E−06 | −2.89278E−08 | 4.34356E−10 | −4.24313E−12 |
| 26 | 1.45409E−06 | −8.77238E−08 | 2.55758E−09 | −2.99822E−11 |
| 35 | 1.06337E−06 | −5.15109E−08 | 1.43873E−09 | −1.36962E−11 |
| 36 | 6.04075E−07 | −3.02481E−08 | 9.34822E−10 | −5.45729E−12 |
| 45 | −1.82283E−08 | 6.73754E−11 | −9.89639E−12 | −1.58022E−12 |
| 46 | 4.01412E−08 | −5.52149E−11 | −3.78338E−11 | 9.66675E−13 |

Please further refer to FIGS. 2C to 2E. FIG. 2C shows a curve chart of field curvature aberrations in a tangential direction when light with wavelengths of 470 nm, 510 nm, 555 nm, 610 nm, and 650 nm is incident on the image capturing lens 10 in the second embodiment. FIG. 2D shows a curve chart of field curvature aberrations in a sagittal direction when the light with wavelengths of 470 nm, 510 nm, 555 nm, 610 nm, and 650 nm is incident on the image capturing lens 10 in the second embodiment. FIG. 2E shows a distortion curve chart when the light with wavelengths of 470 nm, 510 nm, 555 nm, 610 nm, and 650 nm is incident on the image capturing lens 10 in the second embodiment.

As shown in the field curvature aberration curve charts of FIGS. 2C and 2D, the field curvature aberrations of the five representative wavelengths fall within ±0.08 mm across the entire field of view, meaning that the image capturing lens 10 in the second embodiment can effectively eliminate field curvature aberrations. As shown in the distortion curve chart of FIG. 2E, the distortion aberrations of the five representative wavelengths are less than ±0.6% across the entire field of view, meaning that the image capturing lens 10 in the second embodiment has good imaging quality.

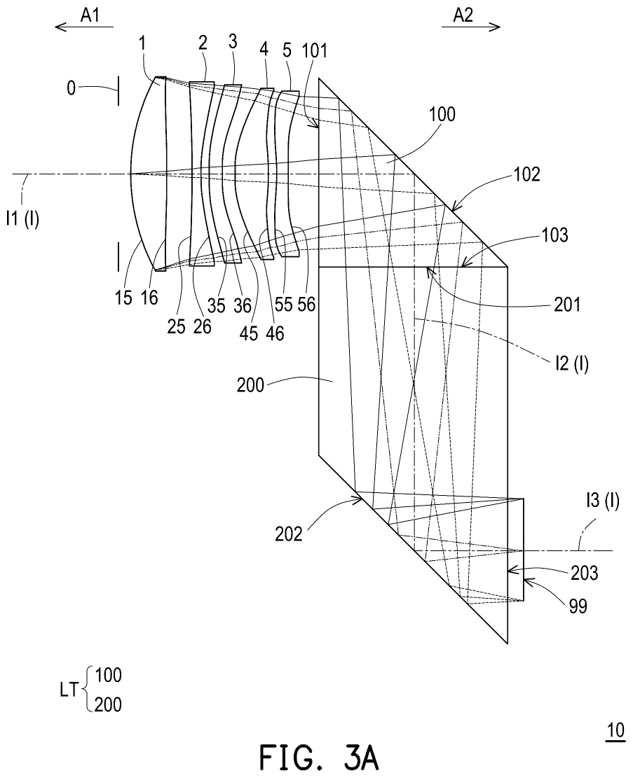

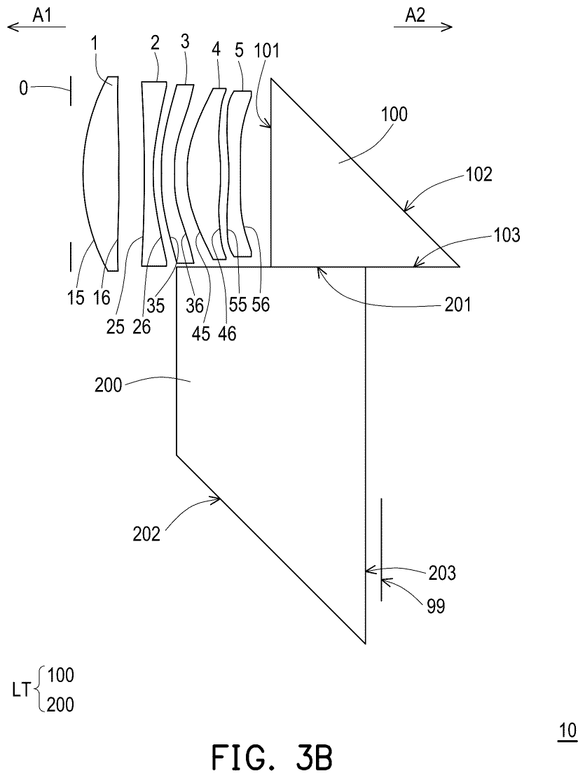

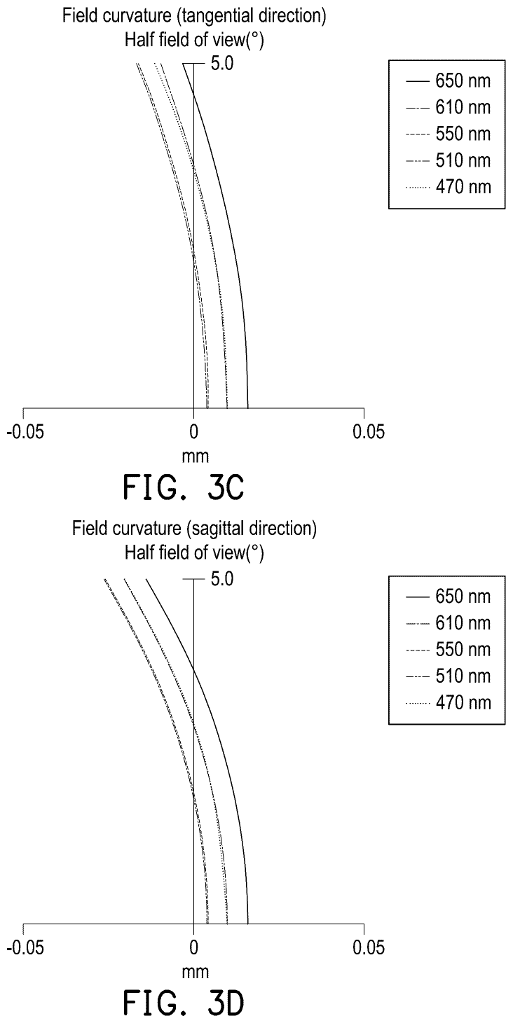

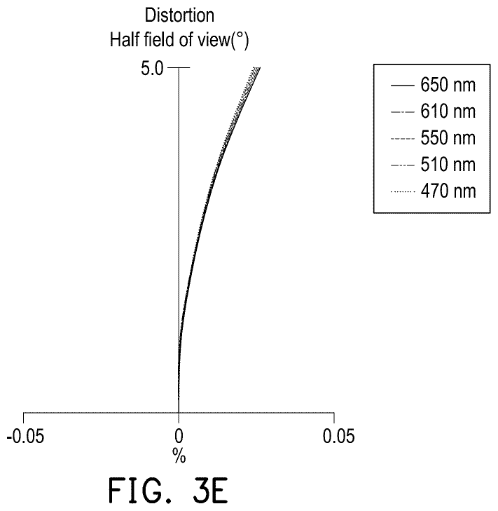

Please refer to FIGS. 3A and 3B, which respectively show a schematic diagram of an image capturing lens in a usage state and a non-usage state according to a third embodiment of the disclosure. The image capturing lens 10 in the third embodiment includes the stop 0, the first lens element 1, the second lens element 2, the fourth lens element 4, the third lens element 3, a fifth lens element 5, and the light turning component LT sequentially from the object side A1 to the image side A2 along the optical axis I of the image capturing lens 10. When light emitted from an object to be imaged enters the image capturing lens 10 and sequentially penetrates the stop 0, the first lens element 1, the second lens element 2, the fourth lens element 4, the third lens element 3, the fifth lens element 5, and the light turning component LT, an image is formed on the image surface 99.

In this embodiment, the first lens element 1, the second lens element 2, the fourth lens element 4, the third lens element 3, and the fifth lens element 5 of the image capturing lens 10 respectively have object side surfaces 15, 25, 45, 35, and 55 facing the object side A1 and allowing imaging light to pass through. The first lens element 1, the second lens element 2, the fourth lens element 4, the third lens element 3, and the fifth lens element 5 of the image capturing lens 10 also respectively have image side surfaces 16, 26, 46, 36, and 56 facing the image side A2 and allowing imaging light to pass through.

The first lens element 1 has positive refracting power, with the optical axis area of the object side surface 15 being a convex surface and the optical axis area of the image side surface 16 being a convex surface. Both the object side surface 15 and the image side surface 16 are aspheric surfaces.

The second lens element 2 has negative refracting power, with the optical axis area of the object side surface 25 being a concave surface and the optical axis area of the image side surface 26 being a concave surface. Both the object side surface 25 and the image side surface 26 are aspheric surfaces.

The fourth lens element 4 has negative refracting power, with the optical axis area of the object side surface 45 being a convex surface and the optical axis area of the image side surface 46 being a concave surface. Both the object side surface 45 and the image side surface 46 are aspheric surfaces.

The third lens element 3 has positive refracting power, with the optical axis area of the object side surface 35 being a convex surface and the optical axis area of the image side surface 36 being a convex surface. Both the object side surface 35 and the image side surface 36 are aspheric surfaces.

The fifth lens element 5 has negative refracting power, with an optical axis area of the object side surface 55 being a concave surface and an optical axis area of the image side surface 56 being a convex surface. Both the object side surface 55 and the image side surface 56 are aspheric surfaces.

The optical axis I includes the first optical axis I1, the second optical axis I2, and the third optical axis I3. The light turning component LT includes the first prism 100 and the second prism 200 configured along the second optical axis I2. The first prism 100 includes the first light incident surface 101, the first reflective surface 102, and the first light exit surface 103. The second prism 200 includes the second light incident surface 201, the second reflective surface 202, and the second light exit surface 203. All of the surfaces are planar surfaces, with the first light exit surface 103 and the second light incident surface 201 being parallel to each other, and the first reflective surface 102 and the second reflective surface 202 being parallel to each other. The first optical axis I1 and the second optical axis I2 intersect at the first reflective surface 102. The second optical axis I2 and the third optical axis I3 intersect at the second reflective surface 202. When light enters the image capturing lens 10 along the first optical axis I1, the light travels along the second optical axis I2 after being reflected by the first reflective surface 102, and then travels along the third optical axis I3 after being reflected by the second reflective surface 202. In some embodiments, the first reflective surface 102 and the second reflective surface 202 may be coated with aluminum and/or silver to increase the reflectivity of light.

When light enters the image capturing lens 10, the light sequentially: penetrates the stop 0, the first lens element 1, the second lens element 2, the fourth lens element 4, the third lens element 3, the fifth lens element 5, and the first light incident surface 101; be reflected by the first reflective surface 102; penetrates the first light exit surface 103 and the second light incident surface 201; be reflected by the second reflective surface 202; and penetrates the second light exit surface 203. The first reflective surface 102 and the second reflective surface 202 are the inner surfaces of the first prism 100 and the second prism 200 respectively.

It should be noted that by configuring the light turning component LT in the image capturing lens 10 in this embodiment, an optical path is folded and thus reduces the length of the image capturing lens 10. Accordingly, the image capturing lens 10 can be accommodated in a limited space, such as a mobile phone case.

Other detailed optical statistics of the third embodiment are shown in Table 5. The image height (ImgH) is half of the diagonal of the image surface 99. The first light incident surface 101, the first reflective surface 102, the first light exit surface 103, the second light incident surface 201, the second reflective surface 202, and the second light exit surface 203 are respectively abbreviated as incident surface 101, reflective surface 102, exit surface 103, incident surface 201, reflective surface 202, and exit surface 203.

TABLE 5
Third Embodiment
Effective focal length = 18.5 mm; Full field of view = 10.0°;
Stop value = 3.0; ImgH = 1.618 mm.

| | | Radius of | | | |
|---|---|---|---|---|---|
| | | curvature | Distance | Refractive | Abbe |
| Element | Surface | (mm) | (mm) | index | number |
| Object | | Infinite | Infinite | | |
| | Stop 0 | Infinite | 0.00 | | |
| First lens | Object side | 6.26 | 1.14 | 1.55 | 56.10 |
| element 1 | surface 15 | | | | |
| | Image side | −156.90 | 0.82 | | |
| | surface 16 | | | | |
| Second lens | Object side | −56.01 | 0.30 | 1.61 | 25.60 |
| element 2 | surface 25 | | | | |
| | Image side | 7.78 | 0.23 | | |
| | surface 26 | | | | |
| Third lens | Object side | 7.46 | 0.41 | 1.55 | 56.10 |
| element 4 | surface 45 | | | | |
| | Image side | 4.75 | 0.42 | | |
| | surface 46 | | | | |
| Third lens | Object side | 4.39 | 1.06 | 1.61 | 25.60 |
| element 3 | surface 35 | | | | |
| | Image side | −16.42 | 0.27 | | |
| | surface 36 | | | | |
| Fifth lens | Object side | −6.814 | 0.36 | 1.69 | 18.40 |
| element 5 | surface 55 | | | | |
| | Image side | −288.670 | 1.00 | | |
| | surface 56 | | | | |
| First prism 100 | Incident | Infinite | 3.00 | 1.84 | 23.78 |
| | surface 101 | | | | |
| | Reflective | Infinite | 3.00 | | |
| | surface 102 | | | | |
| | Exit surface | Infinite | 0.00 | | |
| | 103 | | | | |
| Second prism | Incident | Infinite | 9.00 | 1.84 | 23.78 |
| 200 | surface 201 | | | | |
| | Reflective | Infinite | 3.00 | | |
| | surface 202 | | | | |
| | Exit surface | Infinite | 0.50 | | |
| | 203 | | | | |
| | Image | Infinite | | | |
| | surface 99 | | | | |

In Table 5, the spacing of the object side surface 15 is the thickness of the first lens element 1 along the optical axis I (the first optical axis I1). The spacing of the image side surface 16 is the distance between the image side surface 16 of the first lens element 1 and the object side surface 25 of the second lens element 2 along the optical axis I (the first optical axis I1), i.e., the gap between the first lens element 1 and the second lens element 2 along the optical axis I (the first optical axis I1), and so forth.

A spacing of the image side surface 56 is a distance between the image side surface 56 of the fifth lens element 5 and the first light incident surface 101 of the first prism 100 along the optical axis I (the first optical axis I1), i.e., a gap between the fifth lens element 5 and the first prism 100 along the optical axis I (the first optical axis I1).

The spacing of the first light incident surface 101 is the distance between the first light incident surface 101 and the first reflective surface 102 along the optical axis I (the first optical axis I1). The spacing of the first reflective surface 102 is the distance between the first reflective surface 102 and the first light exit surface 103 along the optical axis I (the second optical axis I2). The spacing of the first light exit surface 103 is the distance between the first light exit surface 103 and the second light incident surface 201 along the optical axis I (the second optical axis I2). The spacing of the second light incident surface 201 is the distance between the second light incident surface 201 and the second reflective surface 202 along the optical axis I (the second optical axis I2). The spacing of the second reflective surface 202 is the distance between the second reflective surface 202 and the second light exit surface 203 along the optical axis I (the third optical axis I3).

The spacing of the second light exit surface 203 is a gap between the second prism 200 and the image surface 99 along the optical axis I (the third optical axis I3).

It should be particularly noted that, according to an embodiment, the image capturing lens 10 may further include a moving mechanism. The moving mechanism is configured to move the first lens element 1, the second lens element 2, the fourth lens element 4, the third lens element 3, and the fifth lens element 5, and the first prism 100 along a stretching direction at the same time, wherein the stretching direction is parallel to the first optical axis I1. During the movement, the gaps between the first lens element 1, the second lens element 2, the fourth lens element 4, the third lens element 3, the fifth lens element 5, and the first prism 100 remain the same as the statistics shown in Table 5. During the movement, there may be a slight gap between the first light exit surface 103 and the second light incident surface 201. Moreover, the moving mechanism moves the first lens element 1, the second lens element 2, the fourth lens element 4, the third lens element 3, the fifth lens element 5, and the first prism 100 by a distance of less than 3 mm. By configuring the moving mechanism, the image capturing lens 10 may switch between the usage state shown in FIG. 3A and the non-usage state shown in FIG. 3B, further reducing the lens length in the non-usage state.

In this embodiment, the object side surfaces 15, 25, 45, 35, and 55 of the first lens element 1, the second lens element 2, the fourth lens element 4, the third lens element 3, and the fifth lens element 5, as well as the image side surfaces 16, 26, 46, 36, and 56 of the first lens element 1, the second lens element 2, the fourth lens element 4, the third lens element 3, and the fifth lens element 5 are all aspheric surfaces. The aspheric surfaces are defined according to the aspheric surface formula (1).

In this embodiment, the conic constant K and each aspheric coefficients in the aspheric surface formula (1) are shown in Table 6. In Table 6, No. 15 indicates the aspheric coefficients of the object side surface 15 of the first lens element 1, and No. 16 indicates the aspheric coefficients of the image side surface 16 of the first lens element 1. The other numbers follow the same analog.

TABLE 6

| Surface | K | a₄ | a₆ | a₈ | a₁₀ |
|---|---|---|---|---|---|
| 15 | 0.00E+00 | −1.25187E−05 | −1.9E−05 | 8.58937E−06 | −9.71341E−07 |
| 16 | 0.00E+00 | −0.001975402 | 0.0008029 | −0.000127654 | 1.1468E−05 |
| 25 | 0.00E+00 | −0.001916443 | 0.0004099 | −4.99505E−05 | 5.07681E−06 |
| 26 | 0.00E+00 | 0.010750539 | −0.004944 | 0.001014746 | −0.000115283 |
| 45 | 0.00E+00 | 0.008199582 | −0.004876 | 0.001001897 | −0.000115112 |
| 46 | 0.00E+00 | 0.004893301 | −0.002249 | 0.00010132 | 1.73208E−05 |
| 35 | 0.00E+00 | 0.005280419 | −0.001029 | −4.26677E−05 | 1.00312E−05 |
| 36 | 0.00E+00 | 0.002953634 | 0.0020591 | −0.000291843 | 1.81671E−05 |
| 55 | 0.00E+00 | 0.02030122 | −0.001325 | 0.000108202 | −9.67159E−06 |
| 56 | 0.00E+00 | 0.02086997 | −0.002477 | 0.00016571 | −6.9201E−06 |

| Surface | a₁₂ | a₁₄ | a₁₆ | a₁₈ | a₂₀ |
|---|---|---|---|---|---|
| 15 | 4.86015E−08 | −1.17639E−09 | 5.85541E−12 | 0.00E+00 | 0.00E+00 |
| 16 | −5.87637E−07 | 1.60084E−08 | −1.8124E−10 | 0.00E+00 | 0.00E+00 |
| 25 | −3.18453E−07 | 1.02067E−08 | −1.25525E−10 | 0.00E+00 | 0.00E+00 |
| 26 | 7.46746E−06 | −2.56898E−07 | 3.63805E−09 | 0.00E+00 | 0.00E+00 |
| 45 | 7.56804E−06 | −2.6107E−07 | 3.65021E−09 | 0.00E+00 | 0.00E+00 |
| 46 | −1.99537E−06 | 4.60187E−08 | 1.70561E−09 | 0.00E+00 | 0.00E+00 |
| 35 | −5.5969E−07 | 1.56181E−08 | −2.39991E−10 | 1.27257E−10 | −2.78026E−11 |
| 36 | −6.35846E−07 | 1.33121E−08 | −1.65627E−10 | 1.13188E−12 | −3.27797E−15 |
| 55 | 5.12947E−07 | −1.50656E−08 | 2.46312E−10 | −1.38314E−10 | 3.17828E−11 |
| 56 | 1.78811E−07 | −2.74017E−09 | 2.27083E−11 | −7.82292E−14 | 0.00E+00 |

Please further refer to FIGS. 3C to 3E. FIG. 3C shows a curve chart of field curvature aberrations in a tangential direction when light with wavelengths of 470 nm, 510 nm, 555 nm, 610 nm, and 650 nm is incident on the image capturing lens 10 in the third embodiment. FIG. 3D shows a curve chart of field curvature aberrations in a sagittal direction when the light with wavelengths of 470 nm, 510 nm, 555 nm, 610 nm, and 650 nm is incident on the image capturing lens 10 in the third embodiment. FIG. 3E shows a distortion curve chart when the light with wavelengths of 470 nm, 510 nm, 555 nm, 610 nm, and 650 nm is incident on the image capturing lens 10 in the third embodiment.

As shown in the field curvature aberration curve charts of FIGS. 3C and 3D, the field curvature aberrations of the five representative wavelengths fall within +0.03 mm across the entire field of view, meaning that the image capturing lens 10 in the third embodiment can effectively eliminate field curvature aberrations. As shown in the distortion curve chart of FIG. 3E, the distortion aberrations of the five representative wavelengths are less than ±0.03% across the entire field of view, meaning that the image capturing lens 10 in the third embodiment has good imaging quality.

According to the above embodiments and other embodiments of the disclosure, the field of view of the image capturing lens 10 ranges from 10 degrees to 25 degrees. The stop value ranges from 2.0 to 3.0. The focal length ranges from 15 mm to 20 mm. The image height ranges from 1.5 mm to 4.0 mm.

In summary, the image capturing lens provided in the embodiment of the disclosure includes a light turning component. By folding an optical path through the light turning component, the length of the image capturing lens is reduced, realizing the purpose of accommodating a long-focus lens in a limited space while maintaining good optical performance for the image capturing lens. The image capturing lens may also include a moving mechanism to further reduce the lens length in the non-usage state.

What is claimed is:

1. An image capturing lens, wherein, sequentially from an object side to an image side along an optical axis, the image capturing lens comprises:
a first lens element, having a refracting power;
a second lens element, having a refracting power;
a third lens element, having a refracting power; and
a light turning component, wherein along the optical axis, the light turning component comprises:
a first prism, comprising a first light incident surface, a first reflective surface, and a first light exit surface; and
a second prism, comprising a second light incident surface, a second reflective surface, and a second light exit surface,
wherein the first light exit surface and the second light incident surface are parallel to each other, and
the optical axis bends at the first reflective surface and the second reflective surface.

2. The image capturing lens according to claim 1, further comprising a moving mechanism, configured to move the first lens element, the second lens element, the third lens element, and the first prism along a stretching direction, wherein a plurality of gaps between the first lens element, the second lens element, the third lens element, and the first prism remain unchanged.

3. The image capturing lens according to claim 2, wherein the optical axis comprises a first optical axis, a second optical axis, and a third optical axis, wherein the first optical axis and the second optical axis intersect at the first reflective surface, the second optical axis and the third optical axis intersect at the second reflective surface, and the first optical axis of the optical axis is parallel to the stretching direction.

4. The image capturing lens according to claim 1, wherein the first reflective surface and the second reflective surface are planar and parallel to each other.

5. The image capturing lens according to claim 1, wherein the first light incident surface and the second light exit surface are planar.

6. The image capturing lens according to claim 1, wherein the first lens element has the positive refracting power.

7. The image capturing lens according to claim 6, wherein the second lens element has the negative refracting power.

8. The image capturing lens according to claim 7, wherein the third lens element has the positive refracting power.

9. The image capturing lens according to claim 8, further comprising a fourth lens element and a fifth lens element, wherein the first lens element, the second lens element, the fourth lens element, the third lens element, and the fifth lens element are sequentially configured along the optical axis from the object side to the image side, the fourth lens element has a negative refracting power, and the fifth lens element has a negative refracting power, such that the image capturing lens comprises a total of five lens elements having the refracting power.

10. The image capturing lens according to claim 8, wherein the third lens element is a biconvex lens element.

11. The image capturing lens according to claim 8, wherein a field of view of the image capturing lens ranges from 10 degrees to 25 degrees.

12. The image capturing lens according to claim 8, wherein a stop value of the image capturing lens ranges from 2.0 to 3.0.

13. The image capturing lens according to claim 8, wherein a focal length of the image capturing lens ranges from 15 mm to 20 mm.

14. The image capturing lens according to claim 8, wherein an image height of the image capturing lens ranges from 1.5 mm to 4.0 mm.

15. The image capturing lens according to claim 8, wherein the image capturing lens comprises a total of three lens elements having the refracting power.

16. The image capturing lens according to claim 8, further comprising a fourth lens element, wherein the first lens element, the second lens element, the third lens element, and the fourth lens element are sequentially configured along the optical axis from the object side to the image side, and the fourth lens element has a positive refracting power, such that the image capturing lens comprises a total of four lens elements having the refracting power.

17. The image capturing lens according to claim 8, wherein the second lens element is a negative meniscus lens element with a concave surface facing the image side.

18. The image capturing lens according to claim 8, wherein the second lens element is a biconcave lens element.

19. The image capturing lens according to claim 8, wherein the first lens element is a positive meniscus lens element with a concave surface facing the image side.

20. The image capturing lens according to claim 8, wherein the first lens element is a biconvex lens element.
